(19) United States
(12) Patent Application Publication
(10) Pub. No.: US 2019/0088095 A1
(43) Pub. Date: Mar. 21, 2019

(54) TERMINAL ANTITHEFT ALARM METHOD AND DEVICE

(71) Applicant: ZTE CORPORATION, Shenzhen, Guangdong (CN)

(72) Inventor: Wei SUN, Shenzhen, Guangdong (CN)

(21) Appl. No.: 16/082,473

(22) PCT Filed: Sep. 27, 2016
(86) PCT No.: PCT/CN2016/100391

§ 371 Date: Sep. 5, 2018

(30) Foreign Application Priority Data
Mar. 8, 2016 (CN) 201610129818.2

(51) Int. Cl. G08B 13/14

(52) U.S. Cl. CPC G08B 13/1472

(57) ABSTRACT

A terminal antitheft alarm method and a terminal antitheft alarm device. The terminal antitheft alarm method comprises: providing at least one set of pressure sensors on the surface of a terminal or that of an external accessory of the terminal, each set of pressure sensors comprising at least two pressure sensors (100); when the surface of the terminal or that of the external accessory of the terminal is pressed, utilizing the at least one set of pressure sensors to collect pressure data (101); when the data pressure collected by any one set of pressure sensors satisfies a preset criterion, generating an alarm signal (102).

### FIELD OF THE INVENTION

The present disclosure relates to terminal anti-theft technologies, and in particular, to a terminal anti-theft alarm method and device.

### BACKGROUND

With the advancement of science and technology and the improvement of living standards, more and more terminal products are used by people. Therefore, anti-theft technologies of terminal products are receiving more and more attention. For example, the mobile phone is a must-have item for everyone's daily life. The mobile phone is easy to be stolen due to small size and flat design thereof. Moreover, the mobile phone has high value and is easy to sell after stolen. Therefore, the mobile phone has become the main valuable item that is often stolen. Although the anti-theft awareness of some users is enhanced and a look-out can be kept for a period of time, the mobile phone is still easily stolen once there is a little careless or thieves deliberately transfer the user's line of sight.

Currently, the mobile phone anti-theft measures are mainly divided into the following types.

1) Use a mobile phone chain for anti-theft. Specifically, a mobile phone chain buckle is arranged on an outer casing of the mobile phone, an end of the mobile phone chain passes through the chain buckle of the mobile phone, and the other end is hung on the belt loop of the user. As such, when the chain of mobile phone is dragged, the user will sense that a stealing behavior is taking place, which can play a role of the mobile phone anti-theft.

Since the mobile phone chain buckle is usually only provided on an old-fashioned mobile phone, this anti-theft measure for mobile phone has a small application range; and when the mobile phone chain buckle is arranged on the mobile phone, an adverse effect on overall aesthetic appearance may be brought to the mobile phone. Further, the mobile phone chain is easy to be cut off, such that the actual anti-theft effect is very poor.

2) In the case where a user carries two mobile phones at the same time, when the two mobile phones are separated by a certain distance, an alarm signal can be sent from one or two mobile phones. For example, in the case where the two mobile phones come into a wireless communication connection via the Bluetooth interconnection technology, when the two mobile phones are close to each other, a Bluetooth signal received by each of the mobile phones is strong, and when a distance between the two mobile phones is getting larger, the Bluetooth signal received by each of the mobile phones becomes weaker. When the strength of the Bluetooth signal of the corresponding mobile phone is less than a preset intensity threshold, an alarm signal can be generated to inform the user of the mobile phone being stolen.

It can be seen that the above anti-theft alarm measure requires the user to carry two mobile phones at the same time, which is inconvenient for the user. In addition, due to the instability of the wireless communication signal, the alarm response speed of the anti-theft alarm measure is relatively slow. If the user is in a place with a dense population, the stolen mobile phone may be already away from the user when the alarm signal is generated. Consequently, it will become difficult to prevent the stealing behavior.

3) Use a mobile phone pocket for anti-theft. Specifically, a seal is designed in a pocket of the user's clothes in which the mobile phone is placed, and the seal can function as the mobile phone anti-theft.

The above anti-theft measure requires a special design on the clothes. For the clothing industry, this anti-theft function may not be a driving force of improvement on clothes. Such clothes are rarely sold in the market, which may lower user experience. In addition, the pocket of the clothes is also easily broken by sharps such that the anti-theft effect may be greatly reduced.

### SUMMARY

In order to solve the above technical problem, embodiments of the present disclosure are intended to provide a terminal anti-theft alarm method and device, without providing other peripheral products and without affecting the appearance of the terminal, thereby improving the user experience.

The technical solutions of the present disclosure are implemented as follows.

In an embodiment of the disclosure, there is provided a method for terminal anti-theft alarm, comprising steps of: providing at least one set of pressure sensors on a surface of a terminal or a surface of an external accessory of the terminal, each set of pressure sensors including two pressure sensors; utilizing at least one set of pressure sensors to collect the pressure data; and generating an alarm signal under the condition that any two pieces of the collected pressure data satisfy a preset criterion.

In the above implementation, the preset criterion is in that two pieces of corresponding pressure data originate from the two pressure sensors in the same set, and pressure directions of the pressure sensors corresponding to the two pieces of pressure data are opposite to each other.

In the above implementation, the preset criterion is further in that values of the two pieces of corresponding pressure data are larger than a first set threshold.

In the above implementation, when the pressure data is collected by using at least one set of pressure sensors, the method further comprises: acquiring identifiers of the pressure sensors corresponding to the respective collected pressure data, and the preset criterion is further in that the identifiers of the pressure sensors corresponding to the two pieces of pressure data are a preset non-security identifier.

In the above implementation, after the pressure data is collected by using at least one set of pressure sensors, the method further comprises: acquiring pressing positions corresponding to the two pieces of pressure data collected, and the preset criterion is further in that the pressing positions corresponding to the two pieces of pressure data are not a preset security position.

In an embodiment of the disclosure, there is provided a device for terminal anti-theft alarm, comprising a setting module, an acquisition module, and a generation module, wherein the setting module is configured to provide at least one set of pressure sensors on a surface of a terminal or a surface of an external accessory of the terminal, each set of pressure sensors including two pressure sensors; the acquisition module is configured to acquire pressure data collected by at least one set of pressure sensors; and the generation module is configured to generate an alarm signal when any two pieces of the collected pressure data satisfy a preset criterion.

In the above implementation, the preset criterion is in that two pieces of corresponding pressure data originate from the two pressure sensors in the same set, and the pressure directions of the pressure sensors corresponding to the two pieces of pressure data are opposite to each other.

In the above implementation, the preset criterion is further in that values of the two pieces of corresponding pressure data are larger than a first set threshold.

In the above implementation, the acquisition module is further configured to acquire identifiers of the pressure sensors corresponding to respective collected pressure data when acquiring the pressure data collected by using at least one set of pressure sensors, and the preset criterion is further in that the identifiers of the pressure sensors corresponding to the two pieces of pressure data are a preset non-security identifier.

In the above implementation, the acquisition module is further configured to acquire pressing positions corresponding to the two pieces of collected pressure data after acquiring the pressure data collected by using at least one set of pressure sensors, and the preset criterion is further in that the pressing positions corresponding to the two pieces of pressure data are not a preset security position.

In an embodiment of the disclosure, there is also provided a device for terminal anti-theft alarm, comprising a controller disposed on a terminal, and at least one set of pressure sensors disposed on the terminal or an external accessory of the terminal, each set of pressure sensors including two pressure sensors, wherein the at least one set of pressure sensors is configured to collect pressure data and send the pressure data collected to the controller; and the controller is configured to generate an alarm signal under the condition that any two pieces of pressure data collected satisfy a preset criterion.

In the above implementation, the preset criterion is in that two pieces of corresponding pressure data originate from the two pressure sensors in the same set, and the pressure directions of the pressure sensors corresponding to the two pieces of pressure data are opposite to each other.

In the above implementation, the preset criterion is further in that values of the two pieces of corresponding pressure data are larger than a first set threshold.

In an embodiment of the disclosure, there is provided a computer storage media storing execution instructions which are provided for achieving of implementation of the terminal anti-theft alarm method according to the above embodiments.

The terminal anti-theft alarm method and device according to the embodiments of the present disclosure, at least one set of pressure sensors is disposed on the surface of the terminal or the external accessory of the terminal, each set of pressure sensors includes two pressure sensors; when the surface of the terminal or the external accessory of the terminal is pressed, the pressure data is collected by using at least one set of pressure sensors; when any two pieces of pressure data collected satisfy the preset criterion, the alarm signal can be generated. In this manner, the pressure sensors provided on the terminal or the external accessory of the terminal can realize the collection of pressure data; and whether to generate the alarm can be determined based on the collected pressure data without providing other peripheral products and without affecting the appearance of the terminal, thereby improving the user experience.

### BRIEF DESCRIPTION OF THE DRAWINGS

FIG. 1 is a flowchart of a method for terminal anti-theft alarm according to a first embodiment of the present disclosure;

FIG. 2 is a schematic diagram showing a structure of a pressure sensor in the method for terminal anti-theft alarm according to the first embodiment of the present disclosure;

FIG. 3 is a schematic diagram showing a layout of each set of pressure sensors on a mobile phone in the method for terminal anti-theft alarm according to the first embodiment of the present disclosure;

FIG. 4 is a flowchart of a method for terminal anti-theft alarm according to a second embodiment of the present disclosure;

FIG. 5 is a schematic diagram showing a structure of a device for terminal anti-theft alarm according to an embodiment of the present disclosure; and

FIG. 6 is another schematic diagram showing another structure of a device for terminal anti-theft alarm according to an embodiment of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure.

Embodiments of the present disclosure provides a terminal anti-theft alarm method and device, which promptly reminds the user that the stealing behavior is taking place without using the terminal peripheral product and affecting the appearance of the terminal, thereby enhancing the anti-theft effect of the terminal. The terminal anti-theft alarm method and device according to the embodiments of the disclosure can be directly configured on various intelligent terminals, and thus can be used for scenes with a large flow of people such as buses, subways, trains, shopping malls, and the like.

Here, the terminal may be a mobile terminal or a fixed terminal, wherein the fixed terminal includes but is not limited to a desktop computer or the like, and the mobile terminal includes but is not limited to a mobile phone, a notebook computer, a tablet computer, and the like.

### First Embodiment

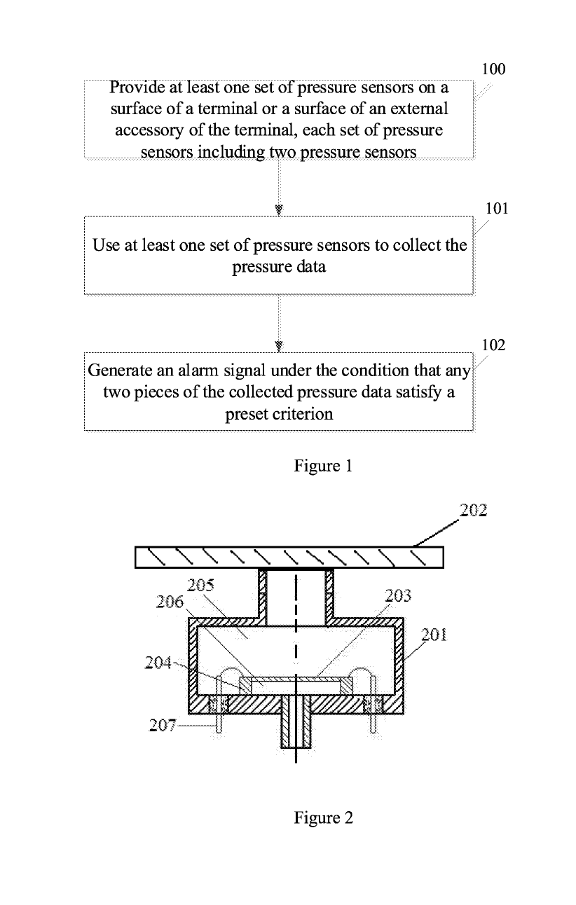

FIG. 1 is a flowchart of a method for terminal anti-theft alarm according to a first embodiment of the present disclosure. As shown in FIG. 1, the process includes steps of:

Step 100: providing at least one set of pressure sensors on a surface of a terminal or a surface of an external accessory of the terminal, each set of pressure sensors including two pressure sensors.

Here, the external accessory of the terminal refers to a directly associated accessory when the terminal is in use. Exemplarily, when the terminal is a mobile phone, the external accessory of the terminal may be a mobile phone case, a mobile phone bag, a stylus, and a hanging rope, a mobile power charger, etc.

Specifically, in each set of pressure sensors, each pressure sensor may be located inside the terminal or an external accessory of the terminal, and each pressure sensor is closely adjacent to the surface of the terminal or the external accessory of the terminal for collecting pressure data when a corresponding surface area is under pressure.

The pressure sensor is configured to collect pressure data when pressed. Specifically, when the surface area immediately adjacent to the pressure sensor is subjected to pressure, the pressure sensor generates a slight deformation, and the generated deformation is converted into corresponding pressure data. Here, each pressure sensor can be a pressure screen on the terminal.

In a practical application, the surface of the terminal or the external accessory of the terminal may have a plurality of faces, and each of the faces constituting the surface of the terminal or the external accessory of the terminal may be flat or curved. Exemplarily when the terminal is a mobile phone, the surfaces of the terminal include an upper surface, a lower surface, a front surface, a rear surface, a left surface, and a right surface, wherein the front surface and the rear surface of the terminal are generally regarded as flat faces and any one of the upper surface, the lower surface, the left surface and the right surface may be considered a curved face or a flat face.

The structure of the pressure sensor will be exemplarily illustrated by way of an example. FIG. 2 is a schematic diagram showing the structure of the pressure sensor in the terminal anti-theft alarm method according to the first embodiment of the present disclosure. As shown in FIG. 2, the pressure sensor is a resistive-pressure sensor including a housing 201 having an opening at an upper end thereof, and the opening at the upper end of the housing 201 is in close contact with an outer casing 202 of the terminal; a silicon diaphragm 203 is disposed inside the housing 201 and parallel to the outer casing 202 above the pressure sensor; the silicon diaphragm 203 is partially overlapped or completely overlapped with the opening of housing 201 in a vertical direction; and a periphery of the silicon diaphragm 203 is fixed by a round silicon ring (silicon cup) 204. At this time, a low-pressure cavity 205 is formed by the housing 201, the outer casing 202 of the terminal, the silicon diaphragm 203, and the round silicon ring (silicon cup) 204, and a high-pressure cavity 206 is formed by the housing 201, the silicon diaphragm 203, and the round silicon ring (silicon cup) 204. The round silicon ring (silicon cup) 204 is also electrically connected with lead wires 207.

For the position of the pressure sensor at the terminal or the external accessory of the terminal, specifically, when each set of pressure sensors is disposed at the terminal, two pressure sensors in each set of pressure sensors are disposed on non-adjacent surfaces of the terminal, respectively.

Here, pressure directions of the two pressure sensors in each set of pressure sensors are opposite, and projections of the two pressure sensors in each set of pressure sensors are partially overlapped or completely overlapped in the pressure direction of any one of the pressure sensors. Exemplarily, in each set of pressure sensors, one pressure sensor is right located at the center of the upper surface of the mobile phone, and the other pressure sensor is right located at the center of the lower surface of the mobile phone, and the projections of the two pressure sensors in the vertical direction are partially overlapped or completely overlapped.

At this time, surface areas in which two sensors in each set of sensors are located may be referred to as symmetrical surface areas. It may be understood that when the symmetrical surface areas are simultaneously subjected to pressure, it is convenient to pick up the terminal.

Since the pressure sensors in each set are located in the symmetrical surface areas of the terminal, pressures applied to the two pressure sensors in each set of pressure sensors are substantially equal. Thus, magnitudes of the voltage signals generated by the two pressure sensors are substantially equal. Thus it can be judged that the corresponding symmetrical surface areas are subjected to pressure.

Exemplarily, when the terminal is a mobile phone, at least one set of pressure sensors may be provided. In each set of pressure sensors, if one pressure sensor is located on the upper surface of the terminal, another pressure sensor is located on the lower surface of the terminal; if one pressure sensor is located on the front surface of the terminal, the other pressure sensor is located on the rear surface of the terminal; if one pressure sensor is located on the upper surface of the terminal, the other pressure sensor is located on the lower surface of the terminal.

For a set of pressure sensors on the upper surface and the lower surface of the terminal, the pressure sensor on the upper surface of the terminal is pressed downward, and the pressure sensor on the lower surface of the terminal is pressed upward. The pressure sensor on the upper surface of the terminal and the pressure sensor on the lower surface of the terminal are completely overlapped or partially overlapped in an upward or downward direction.

For a set of pressure sensors on the front and rear surfaces of the terminal, the pressure sensor on the front surface of the terminal is pressed backward, and the pressure sensor on the rear surface of the terminal is pressed forward. The pressure sensor on the front surface of the terminal and the pressure sensor on the rear surface of the terminal are completely overlapped or partially overlapped in a forward or backward direction.

For a set of pressure sensors on the left and right surfaces of the terminal, the pressure sensor on the left surface of the terminal is pressed rightward, and the pressure sensor on the right surface of the terminal is pressed leftward. The pressure sensor on the left surface of the terminal and the pressure sensor on the right surface of the terminal are completely overlapped or partially overlapped in a left or right direction.

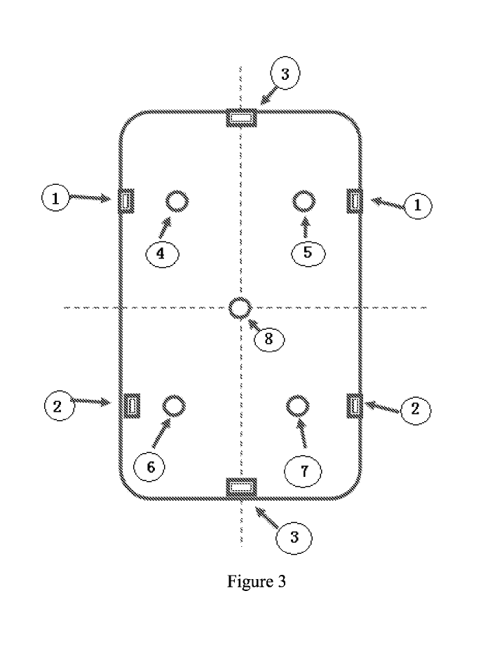

FIG. 3 is a schematic diagram showing a layout of each set of pressure sensors on a mobile phone in a terminal anti-theft alarm method according to the first embodiment of the of the present disclosure. As shown in FIG. 3, eight sets of pressure sensors are arranged on surfaces of the mobile phone in total, wherein, the i-th set of pressure sensor is referred to as a combination i, wherein i is taken from 1 to 8. In FIG. 3, \textcircled{1} indicates the first set of pressure sensors, \textcircled{2} indicates the second set of pressure sensors, \textcircled{3} indicates the third set of pressure sensors, \textcircled{4} indicates the fourth set of pressure sensors, \textcircled{5} indicates the fifth set of pressure sensors, \textcircled{6} indicates the sixth set of pressure sensors, \textcircled{7} indicates the seventh set of pressure sensors, and \textcircled{8} indicates the eighth set of pressure sensors, wherein the pressure sensors in each set are located in the symmetrical surface area of the mobile phone, the two pressure sensors in the combination 1 are located on the left and right surfaces of the mobile phone, respectively, the two pressure sensors in the combination 2 are located on the left and right surfaces of the mobile phone, respectively, the two pressure sensors in the combination 3 are located on the upper and lower surfaces of the mobile phone, respectively, and two pressure sensors in each of the remaining sets are located on the front and rear surfaces of the mobile phone, respectively. In FIG. 3, for the fourth set of pressure sensors to the eighth set of pressure sensors, only one of pressure sensors on the front surface is schematically illustrated, while the pressure sensors on the rear surface are not shown.

Hereinafter, force analysis on a terminal when the terminal is being stolen will be made by taking a mobile phone as an example of the terminal.

When the mobile phone is taken out of the user's clothes or a bag, it is sure that the two surfaces of the mobile phone that are not adjacent to each other are pressed to pick up the mobile phone. The two surfaces of the mobile phone that are not adjacent to each other may be the upper surface and the lower surface, or may be the front surface and the rear surface, or the left surface and the right surface.

According to the mechanics principle, for a rectangular parallelepiped object such as a mobile phone, if only the adjacent surfaces are under pressure, the mobile phone cannot be picked up. Based on the principle of the lever, when pressure is applied to the surfaces of the mobile phone that are not adjacent to move the mobile phone, the mobile phone can be clamped by applying the pressure both to the symmetrical surface area of the mobile phone. As such, the mobile phone can be moved.

It can be seen that after each set of pressure sensors collects corresponding pressure data, whether the stealing behavior of the mobile phone is taking place can be determined based on the collected pressure data. Exemplarily, after at least one set of pressure sensors collects the corresponding pressure data, an alarm signal can be sent out based on the collected pressure data to inform the user of the stealing behavior taking place.

Step 101: utilizing at least one set of pressure sensors to collect the pressure data.

Here, after the pressure data is acquired by using at least one set of pressure sensors, it may be determined that the surface of the terminal or the external accessory of the terminal is pressed.

Exemplarily, referring to FIG. 2, when the outer casing 202 is pressed, a slight mechanical deformation can be generated, so that the pressure in the low-pressure cavity is increased. In this way, a force is applied to the silicon diaphragm 203 so that the silicon diaphragm 203 is also slightly deformed. A plurality of piezo-resistors are printed on the lower surface of the silicon diaphragm 203, and the piezo-resistors are connected to each other to form a Wheatstone bridge, to both ends of which the lead wires 207 are connected, respectively. As such, based on the piezo-resistance effect of the piezo-resistors, the Wheatstone bridge may output corresponding pressure data via the lead wires. Here, the output pressure data can be a current signal or a voltage signal.

Due to a regionality of the pressing position at the terminal, it is necessary to appropriately arrange the pressure sensors according to the size and shape of the terminal. When the silicon diaphragm in the pressure sensor generates a micro-displacement proportional to the pressure, a resistance value of the piezo-resistor of the pressure sensor is changed. The change of the resistance value causes the Wheatstone bridge to generate a highly linear voltage signal proportional to the pressure and proportional to the excitation voltage. The standard signal is calibrated as 2.0/3.0/3.3 mV, etc., depending on the pressure range.

Step 102: generating an alarm signal under the condition that any two pieces of the collected pressure data satisfy a preset criterion.

The preset criterion will be described below in several situations.

The First Situation

The preset criterion is in that two pieces of corresponding pressure data originate from the two pressure sensors in the same set, and the pressure directions of the pressure sensors corresponding to the two pieces of pressure data are opposite to each other.

Obviously, when two pieces of corresponding pressure data originate from the two pressure sensors in the same set, the pressure sensors corresponding to the two pieces of pressure data are the two pressure sensors in the same set. Here, the pressure direction of each pressure sensor is usually determined by its position at the terminal or the external accessory of the terminal. For example, the pressure sensor disposed on the upper surface of the terminal is pressed downward, and the pressure sensor disposed on the lower surface of the terminal is pressed upward. Therefore, the pressure direction of each pressure sensor can be predetermined based on the position of each pressure sensor at the terminal or the external accessory of the terminal. As such, with the determination of the source of the corresponding two pieces of pressure data, it can be judged whether the pressure directions of the pressure sensors corresponding to the two pieces of pressure data are opposite based on the predetermined pressure direction of each pressure sensor.

The Second Situation

The preset criterion is in that two pieces of corresponding pressure data originate from the two pressure sensors in the same set, the pressure directions of the pressure sensors corresponding to the two pieces of pressure data are opposite to each other, and values of the two pieces of corresponding pressure data are larger than a first set threshold.

Alternatively, the preset criterion is in that two pieces of corresponding pressure data originate from the two pressure sensors in the same set, the pressure directions of the pressure sensors corresponding to the two pieces of pressure data are opposite to each other, values of the two pieces of corresponding pressure data are larger than a first set threshold, and a difference between the two pieces of corresponding pressure data is smaller than a second set threshold.

It can be seen that when the value of the pressure data is less than or equal to the first set threshold, the corresponding pressure data can be ignored to avoid a situation where an alarm is generated by the user's false trigger.

Here, the first set threshold and the second set threshold may be set according to actual application requirements. For example, the first set threshold is 1 mV, and the second set threshold is 0.2 mV.

The Third Situation

When the pressure data is collected by using at least one set of pressure sensors, identifiers of the pressure sensors corresponding to the respective collected pressure data are acquired.

The preset criterion is in that two pieces of corresponding pressure data originate from the two pressure sensors in the same set, the pressure directions of the pressure sensors corresponding to the two pieces of pressure data are opposite to each other, and the identifiers of the pressure sensors corresponding to the two pieces of pressure data are a preset non-security identifier.

Alternatively, the preset criterion is in that two pieces of corresponding pressure data originate from the two pressure sensors in the same set, the pressure directions of the pressure sensors corresponding to the two pieces of pressure data are opposite to each other, values of the two pieces of corresponding pressure data are larger than a first set threshold, and the identifiers of the pressure sensors corresponding to the two pieces of pressure data are a preset non-security identifier.

Here, the preset non-security identifier is a collection of identifiers of at least two pressure sensors, and the identifier of each pressure sensor may be an identification number (ID) of the pressure sensor or a number assigned in advance to the pressure sensor. It should be noted that the numbers assigned in advance to the pressure sensors of the terminal or the external accessory of the terminal are different from each other.

The Fourth Situation

When the pressure data is collected by using at least one set of pressure sensors, the positions of the pressure sensors corresponding to the respective collected pressure data are acquired.

The preset criterion is in that two pieces of corresponding pressure data originate from the two pressure sensors in the same set, the pressure directions of the pressure sensors corresponding to the two pieces of pressure data are opposite to each other, and the pressing positions corresponding to the two pieces of pressure data are not a preset security position.

Alternatively, the preset criterion is in that two pieces of corresponding pressure data originate from the two pressure sensors in the same set, the pressure directions of the pressure sensors corresponding to the two pieces of pressure data are opposite to each other, values of the two pieces of corresponding pressure data are larger than a first set threshold, and the pressing positions corresponding to the two pieces of pressure data are not a preset security position.

Here, each pressing position corresponding to the pressure data is a position pressed on the terminal or the external accessory of the terminal. The position pressed on the terminal or the external accessory of the terminal can be acquired in various manners in the related art. Exemplarily, the position corresponding to each pressure sensor may be preset, and when the sources corresponding to the two pieces of pressure data are acquired, the pressing positions corresponding to the two pieces of pressure data may be acquired.

Here, the user presets a security location area on the terminal surface or the external accessory surface of the terminal. If the pressing positions corresponding to the two pieces of pressure data are the preset security position, it may be considered that the user personally picks up the terminal or the external accessory of the terminal. At this time, the two pieces of corresponding pressure data do not satisfy with the preset criterion, so that no alarm signal is generated; if the pressing positions corresponding to the two pieces of pressure data are not the preset security position, it may be indicated that a stealing behavior is taking place. At this time, the two pieces of corresponding pressure data satisfy with the preset criterions, thereby generating an alarm signal to inform the user of the stealing behavior taking place.

In this step, the generated alarm signal may be an audible alarm signal, an optical alarm signal, or the like.

In practical applications, after the pressure data is collected, the collected pressure data may be received by a controller of the terminal, and then the controller of the terminal judges whether any two pieces of collected pressure data satisfy the preset criterion. When any two pieces of collected pressure data satisfy the preset criterions, an alarm signal is generated and a speaker is controlled to emit an audible alarm signal.

It can be understood that when the pressure sensor is disposed on the external accessory of the terminal, a data transmission channel is required to be established between the terminal and the external accessory of the terminal, so that the terminal receives the pressure data collected by the pressure sensor through the data transmission channel. At this time, the speaker can also be provided on the external accessory of the terminal. As such, when any two pieces of collected pressure data satisfy the preset criterion, the controller of the terminal sends an alarm control signal to the speaker through the data transmission channel. The speaker emits an audible alarm signal under the control of the alarm control signal.

Further, when any two collected pressure data satisfy the preset criterion, the terminal may also be locked. As such, when the user picks up the terminal by himself/herself, the terminal may be unlocked, and then the user manually turns off the device generating the alarm signal.

In the terminal anti-theft alarm method according to the first embodiment of the present disclosure, the triggering process of the terminal anti-theft alarm mechanism may include:

S1: The user may first set a security location area, and an alarm is not triggered when the user picks up the terminal by pressing the security location area; or the user may not set the security location area.

S2: The user controls the pressure sensor to start working.

S3: When the terminal is pressed, it is judged whether any two pieces of collected pressure data satisfy the preset criterion, and if any two pieces of collected pressure data satisfy the preset criterion, an alarm is made; otherwise, no alarm is made.

S4: When the user picks up the terminal by himself/herself, the terminal can be unlocked, and then the user manually turns off the device that generates the alarm signal.

It can be understood that, in step 102, if two pieces of pressure data satisfying the preset criterion do not exist, no alarm signal is generated.

With the application of the terminal anti-theft alarm method according to the first embodiment of the present disclosure, the pressure sensors provided on the terminal or the external accessory of the terminal can realize the collection of pressure data; and whether to generate the alarm can be determined based on the collected pressure data without providing other peripheral products and without affecting the appearance of the terminal. In addition, by presetting the security location area, the alarm signal can be prevented when the user picks up the terminal by himself/herself, thereby improving the user experience.

### Second Embodiment

In order to further embody the objective of the present disclosure, further illustration will be made on the basis of the first embodiment of the present disclosure.

In the second embodiment of the present disclosure, the terminal is a mobile phone. A plurality of pressure sensors are disposed in the mobile phone in advance, and positions of the pressure sensors disposed in the mobile phone are shown in FIG. 3. According to the sensitivity range of the pressure sensor, a plurality of sets of pressure sensors are arranged on one side of the mobile phone having a larger area or length (left/right sides and front/back sides). For example, five sets of pressure sensors are arranged on front and rear sides, respectively, which are combination 4 to combination 8. When the mobile phone is pressed, a tiny mechanical deformation can be generated at the pressing position. A diaphragm in the pressure sensor produces a micro-displacement proportional to the pressure, which changes a resistance value of the pressure sensor. This change causes the Wheatstone bridge to generate a highly linear voltage signal proportional to the pressure and proportional to the excitation voltage. The signal is calibrated as 2.0/3.0/3.3 mV, etc., depending on the pressure range. The voltage signal output from the pressure sensor combination closest to the pressing position is the strongest, and the output voltage signals of the two pressure sensors in the combination are also the closest, such that the alarm system hereby determines that the area controlled by this combination is pressed by an external force. At this time an alarm signal is given off.

Exemplarily, with reference to FIG. 3, a position of the combination 6 can be set as a security location area, and positions of the remaining pressure sensors can be recorded as alarm locations. Thus, in the case where the terminal anti-theft alarm mechanism is enabled, when the pressing position matches with the position of the combination 6, no alarm signal is generated; when the pressing position does not match with the position of the combination 6 while matching with the positions of the remaining pressure sensors, an alarm signal is generated.

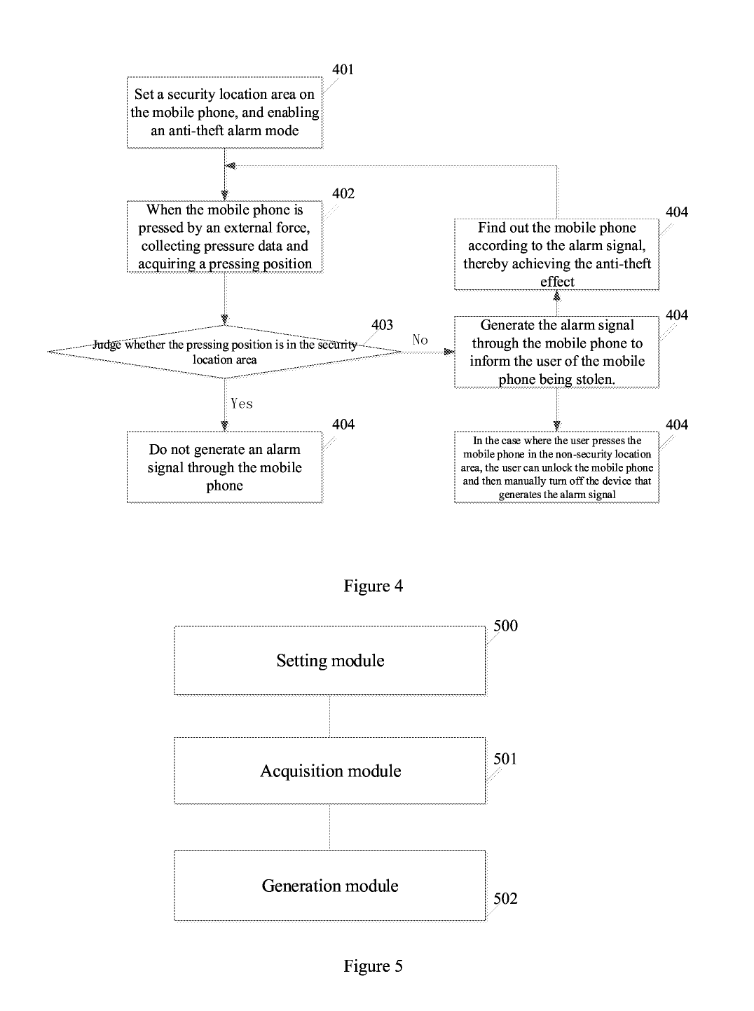

FIG. 4 is a flowchart of a method for terminal anti-theft alarm according to a second embodiment of the present disclosure. As shown in FIG. 4, the process includes:

Step 401: setting a security location area on the mobile phone, and enabling an anti-theft alarm mode.

Here, after the anti-theft alarm mode is enabled, the pressure sensors start to work.

Step 402: when the mobile phone is pressed by an external force, collecting pressure data and acquiring a pressing position.

Step 403: judging whether the pressing position is in the security location area.

Step 404: under the condition that the pressing position is in the security location area, not generating an alarm signal through the mobile phone; or under the condition that the pressing position is not in the security location area, generating the alarm signal through the mobile phone to inform the user of the mobile phone being stolen.

In this step, if the pressing position is in the security location area, a current interface may be switched to an unlocking interface for the user to unlock. If the pressing position is not in the security location area, the current interface can be switched to the unlocking interface while the alarm signal is generated, and the user can find out the mobile phone according to the alarm signal, thereby achieving the anti-theft effect. At this time, the process can return to Step 402.

In the case where the user presses the mobile phone in the non-security location area, the user can unlock the mobile phone and then manually turn off the device that generates the alarm signal.

With the application of the terminal anti-theft alarm method according to the second embodiment of the present disclosure, it is possible to collect the pressure data by providing the pressure sensors on the terminal or the external accessory of the terminal, and determine whether to alarm based on the collected pressure data without providing other peripheral products and affecting the appearance of the terminal. In addition, by presetting the security location area, the alarm signal can be prevented when the user picks up the terminal by himself/herself, thereby improving the user experience.

### Third Embodiment

Correspondingly to the terminal anti-theft alarm method according to the first embodiment of the present disclosure, there is provided a terminal anti-theft alarm device according to the third embodiment of the present disclosure.

FIG. 5 is a schematic diagram showing a structure of a device for terminal anti-theft alarm according to an embodiment of the present disclosure. As shown in FIG. 5, the device includes: a setting module 500, an acquisition module 501, and a generation module 502, wherein

the setting module 500 is configured to provide at least one set of pressure sensors on a surface of a terminal or a surface of an external accessory of the terminal, each set of pressure sensors including two pressure sensors;

the acquisition module 501 is configured to acquire pressure data collected by at least one set of pressure sensors; and

the generation module 502 is configured to generate an alarm signal when any two pieces of the collected pressure data satisfy a preset criterion.

Here, the preset criterion is in that two pieces of corresponding pressure data originate from the two pressure sensors in the same set, and the pressure directions of the pressure sensors corresponding to the two pieces of pressure data are opposite to each other.

Further, the preset criterion is further in that values of the two pieces of corresponding pressure data are larger than a first set threshold.

Further, the acquisition module 501 is configured to acquire identifiers of the pressure sensors corresponding to respective collected pressure data when acquiring the pressure data collected by using at least one set of pressure sensors.

The preset criterion is further in that the identifiers of the pressure sensors corresponding to the two pieces of pressure data are a preset non-security identifier.

Further, the acquisition module 501 is configured to acquire pressing positions corresponding to the two pieces of collected pressure data after acquiring the pressure data collected by using at least one set of pressure sensors.

The preset criterion is further in that the pressing positions corresponding to the two pieces of pressure data are not a preset security position.

In an actual application, the setting module 500, the acquisition module 501, and the generation module 502 may each be implemented by a Central Processing Unit (CPU), a Micro Processor Unit (MPU), and a Digital Signal Processor (DSP) or a Field Programmable Gate Array (FPGA) positioned in the terminal.

### Fourth Embodiment

Correspondingly to the terminal anti-theft alarm method according to the first embodiment of the present disclosure, there is provided a terminal anti-theft alarm device according to the fourth embodiment of the present disclosure.

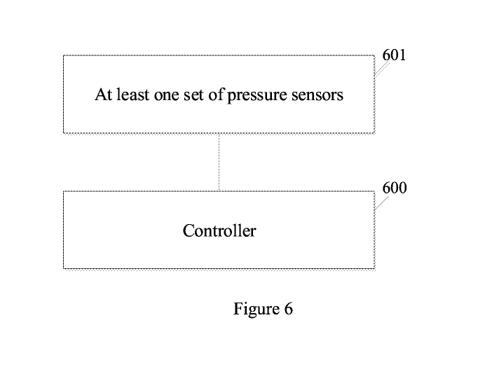

FIG. 6 is another schematic diagram showing another structure of a device for terminal anti-theft alarm according to an embodiment of the present disclosure. As shown in FIG. 6, the device includes: a controller 600 disposed on a terminal, and at least one set of pressure sensors 601 disposed on the terminal or an external accessory of the terminal.

The at least one set of pressure sensors 601 is configured to collect pressure data and send the pressure data collected to the controller.

The controller 600 is configured to generate an alarm signal under the condition that any two pieces of pressure data collected satisfy a preset criterion.

Further, the preset criterion is in that two pieces of corresponding pressure data originate from the two pressure sensors in the same set, and the pressure directions of the pressure sensors corresponding to the two pieces of pressure data are opposite to each other.

Further, the preset criterion is further in that values of the two pieces of corresponding pressure data are larger than a first set threshold.

Further, the controller 600 is configured to acquire identifiers of the pressure sensors corresponding to respective collected pressure data when the collected pressure data is received.

The preset criterion is further in that the identifiers of the pressure sensors corresponding to the two pieces of pressure data are a preset non-security identifier.

Further, the controller 600 is configured to acquire pressing positions corresponding to the two pieces of collected pressure data after the collected pressure data is received.

The preset criterion is further in that the pressing positions corresponding to the two pieces of pressure data are not the preset security position.

In practical applications, the controller 600 can be implemented with a central processing unit inside the terminal, and each pressure sensor may be a pressure screen on the terminal.

Those skilled in the art will appreciate that embodiments of the present disclosure can be embodied as a method, system, or computer program product. Accordingly, the present disclosure can be provided in the form of a hardware embodiment, a software embodiment, or a combination of software and hardware. Moreover, the disclosure can take the form of a computer program product embodied on one or more computer usable storage media (including but not limited to disk storage and optical storage, etc.) in which computer usable program code is included.

The present disclosure has been described with reference to flowchart and/or block diagrams of methods, apparatus (system), and computer program products according to embodiments of the disclosure. It will be understood that these computer program instructions can used to implement each flow and/or block of the flowchart and/or block diagram and a combination of flows and/or blocks of the flowchart and/or block diagram. These computer program instructions can be provided to a processor of a general purpose computer, special purpose computer, embedded processor, or other programmable data processing device to produce a machine such that the instructions for execution by the processor of the computer or other programmable data processing device generate a means for implementing the functions specified in one or more flows of the flowchart or in one or more blocks of the block diagram.

These computer program instructions may also be stored in a computer readable memory that can boot a computer or other programmable data processing device to operate in a particular manner, such that instructions stored in the computer readable memory produce an article including an instruction means. The instruction means can implement the functions specified in one or more flows of the flowchart or in one or more blocks of the block diagram.

These computer program instructions can also be loaded onto a computer or other programmable data processing devices such that a series of operational steps can be performed on the computer or other programmable devices to produce computer-implemented processing. In such a manner, the instructions executed by the computer or other programmable devices provide steps for implementing the functions specified in one or more flows of the flowchart or in one or more blocks of the block diagram.

The above description is only for the preferred embodiments of the present disclosure and is not intended to limit the scope of the present disclosure.

### INDUSTRIAL APPLICABILITY

The above implementations according to the embodiments of the present disclosure can be used in the process of the terminal anti-theft alarm, wherein, at least one set of pressure sensors is disposed on the surface of the terminal or the external accessory of the terminal, each set of pressure sensors includes two pressure sensors; when the surface of the terminal or the external accessory of the terminal is pressed, the pressure data is collected by using at least one set of pressure sensors; when any two pieces of pressure data collected satisfy the preset criterion, the alarm signal can be generated. In this manner, the pressure sensors provided on the terminal or the external accessory of the terminal can realize the collection of pressure data; and whether to generate an alarm can be determined based on the collected pressure data without providing other peripheral products and without affecting the appearance of the terminal.

1-13. (canceled)

14. A method for terminal anti-theft alarm, comprising steps of:
providing at least one set of pressure sensors on a surface of a terminal or a surface of an external accessory of the terminal, each set of pressure sensors including two pressure sensors;
utilizing at least one set of pressure sensors to collect the pressure data; and
generating an alarm signal under the condition that any two pieces of the collected pressure data satisfy a preset criterion.

15. The method according to claim 14, wherein
the preset criterion is in that two pieces of corresponding pressure data originate from the two pressure sensors in the same set, and pressure directions of the pressure sensors corresponding to the two pieces of pressure data are opposite to each other.

16. The method according to claim 15, wherein
the preset criterion is further in that values of the two pieces of corresponding pressure data are larger than a first set threshold.

17. The method according to claim 15, wherein
when the pressure data is collected by using at least one set of pressure sensors, the method further comprises: acquiring identifiers of the pressure sensors corresponding to the respective collected pressure data, and
the preset criterion is further in that the identifiers of the pressure sensors corresponding to the two pieces of pressure data are a preset non-security identifier.

18. The method according to claim 16, wherein
when the pressure data is collected by using at least one set of pressure sensors, the method further comprises: acquiring identifiers of the pressure sensors corresponding to the respective collected pressure data, and
the preset criterion is further in that the identifiers of the pressure sensors corresponding to the two pieces of pressure data are a preset non-security identifier.

19. The method according to claim 15, wherein
after the pressure data is collected by using at least one set of pressure sensors, the method further comprises: acquiring pressing positions corresponding to the two pieces of collected pressure data, and
the preset criterion is further in that the pressing positions corresponding to the two pieces of pressure data are not a preset security position.

20. The method according to claim 16, wherein
after the pressure data is collected by using at least one set of pressure sensors, the method further comprises: acquiring pressing positions corresponding to the two pieces of collected pressure data, and
the preset criterion is further in that the pressing positions corresponding to the two pieces of pressure data are not a preset security position.

21. A device for terminal anti-theft alarm, comprising a setting module, an acquisition module, and a generation module, wherein
the setting module is configured to provide at least one set of pressure sensors on a surface of a terminal or a surface of an external accessory of the terminal, each set of pressure sensors including two pressure sensors;
the acquisition module is configured to acquire pressure data collected by at least one set of pressure sensors; and
the generation module is configured to generate an alarm signal when any two pieces of the collected pressure data satisfy a preset criterion.

22. The device according to claim 21, wherein
the preset criterion is in that two pieces of corresponding pressure data originate from the two pressure sensors in the same set, and the pressure directions of the pressure sensors corresponding to the two pieces of pressure data are opposite to each other.

23. The device according to claim 22, wherein
the preset criterion is further in that values of the two pieces of corresponding pressure data are larger than a first set threshold.

24. The device according to claim 22, wherein
the acquisition module is further configured to acquire identifiers of the pressure sensors corresponding to respective collected pressure data when acquiring the pressure data collected by using at least one set of pressure sensors, and
the preset criterion is further in that the identifiers of the pressure sensors corresponding to the two pieces of pressure data are a preset non-security identifier.

25. The device according to claim 23, wherein
the acquisition module is further configured to acquire identifiers of the pressure sensors corresponding to respective collected pressure data when acquiring the pressure data collected by using at least one set of pressure sensors, and
the preset criterion is further in that the identifiers of the pressure sensors corresponding to the two pieces of pressure data are a preset non-security identifier.

26. The device according to claim 22, wherein
the acquisition module is further configured to acquire pressing positions corresponding to the two pieces of collected pressure data after acquiring the pressure data collected by using at least one set of pressure sensors, and
the preset criterion is further in that the pressing positions corresponding to the two pieces of pressure data are not a preset security position.

27. The device according to claim 23, wherein
the acquisition module is further configured to acquire pressing positions corresponding to the two pieces of collected pressure data after acquiring the pressure data collected by using at least one set of pressure sensors, and
the preset criterion is further in that the pressing positions corresponding to the two pieces of pressure data are not a preset security position.

28. A device for terminal anti-theft alarm, comprising a controller disposed on a terminal, and at least one set of pressure sensors disposed on the terminal or an external accessory of the terminal, each set of pressure sensors including two pressure sensors, wherein
the at least one set of pressure sensors is configured to collect pressure data and send the pressure data collected to the controller; and
the controller is configured to generate an alarm signal under the condition that any two pieces of pressure data collected satisfy a preset criterion.

29. The device according to claim 28, wherein
the preset criterion is in that two pieces of corresponding pressure data originate from the two pressure sensors in the same set, and the pressure directions of the pressure sensors corresponding to the two pieces of pressure data are opposite to each other.

30. The device according to claim 29, wherein
the preset criterion is further in that values of the two pieces of corresponding pressure data are larger than a first set threshold.
